(19) United States
(12) Patent Application Publication
(10) Pub. No.: US 2011/0197579 A1
(43) Pub. Date: Aug. 18, 2011

(54) Thermostatic working element and method for manufacturing a thermostatic working element

(76) Inventors: Hans Wahler, Esslingen (DE); Bernd Bareis, Taeferrot-Utzstetten (DE); Klaus Kasper, Oberkirch (DE)

(21) Appl. No.: 12/909,390

(22) Filed: Oct. 21, 2010

(30) Foreign Application Priority Data
Feb. 18, 2010 (DE) 10 2010 008 496.4

(51) Int. Cl. F03G 7/06; B23P 17/00

(52) U.S. Cl. 60/527; 29/527.1

(57) ABSTRACT

A thermostatic working element has a housing that contains an expansion material, the volume of which is dependent on temperature, and which is used as a means for expelling a working piston. An additive of ground natural graphite is blended with the expansion material.

### CROSS-REFERENCE TO RELATED APPLICATION

The invention described and claimed hereinbelow is also described in German Patent Application DE 10 2010 008 496.4 filed on Feb. 18, 2010. This German Patent Application, whose subject matter is incorporated here by reference, provides the basis for a claim of priority of invention under 35 U.S.C. 119(a)-(d).

### BACKGROUND OF THE INVENTION

The invention relates to a thermostatic working element comprising a housing that contains an expansion material, the volume of which is dependent on temperature, and which is used as a means for expelling a working piston. The invention furthermore relates to a method for manufacturing a thermostatic working element.

Efforts were made in the past to improve the thermal conduction of thermostatic working elements and therefore to shorten their reaction time. It is known e.g. to blend metallic additives in the form of brass chips or aluminum powder, for instance, with the expansion material for this purpose. These additives have the disadvantage that the mixture of expansion material and additive separates over time, with the result that the reaction behavior of the thermostatic working element changes. The reaction time increases. The disadvantage is that this takes place over the course of using working elements of this type, without it becoming apparent in manner other than to be measured. Even if changes of this type are identified, they typically cannot be eliminated. It has already been proposed to add expanded graphite to the expansion material. The use of an expandable graphite of this type is laborious and expensive. The manufacture of expandable graphite alone is very costly. A further disadvantage is that of inserting a mixture of this type, in solid form, into the housing of the thermostatic working element. This is laborious as well, and is possible only if the housing has smooth, continuous inner walls if the intention is to completely fill the interior of the housing.

### SUMMARY OF THE INVENTION

The object of the invention is to create a thermostatic working element of the type described initially, in the case of which the response time has been improved using simple, cost-effective means, and which is maintained for the longest possible period of use without the reaction time changing.

In keeping with these objects and with others which will become apparent hereinafter, one feature of the present invention resides, briefly stated, in a thermostatic working element, comprising a housing containing an expansion material, a volume of which is dependent on temperature, and which is used as means for expelling a working piston; and an additive of ground natural graphite blended with the expansion material. Combining an additive of this type, which is composed of ground natural graphite, to the expansion material has several advantages. The additive is easily incorporated, contains very homogeneous particles, and does not tend to form sediment. The risk of the mixture of expansion material and additive separating and, therefore, of the reaction time changing does not exist. The additive also ensures high thermal conductivity and provides the advantage of increased lubricity due to the coefficient of friction being reduced.

A thermostatic working element can be advantageous that contains a housing and an expansion material, the volume of which is dependent on temperature, and which is used to expel a working piston, wherein the housing interior contains only expansion material, e.g. wax, or a mixture of expansion material and additive in the form of ground natural graphite. In both cases it is advantageous if means for increasing the thermal conductivity between the housing and the expansion material, e.g. metallic conducting elements and/or conducting particles, are contained in the interior of the housing. The means can be formed of intermediate layers. Means that are formed of inner projections and/or recesses on the inside of the housing, e.g. of ribs, thread turns of an interior thread, or the like, are particularly advantageous.

A particularly advantageous embodiment of a thermostatic working element results when the interior, which contains a mixture of expansion material and ground natural graphite, is tightly closed using a diaphragm, on top of which the working piston rests, and via which the working piston can be expelled. A working element of this type has the advantage of markedly reduced friction, thereby resulting in a short actuating time and high control accuracy. A working element of this type can be heated e.g. using an electric heating element. It can be advantageous if an electric heating element fastened to the housing is contained in the interior of the housing, the electric heating element being in at least indirect physical contact with the mixture of expansion material and additive. The electric heating element can be advantageously formed of an electrically heated pin element that extends from the base of the housing into the interior of the housing. It can be advantageous if the pin element in the interior contains at least one electric heating coil that is supplied by lines that extend into the pin element from the outside. The heating element, in particular in the form of the electrically heated pin element, is securely and tightly connected to the housing of the working element. The fastening can take place via a press fit, soldering, welding, a threaded connection, or the like.

The inner heating element in the form of the heating rod has the particular advantage that the heat input brought about by the heating in the housing interior and in the mixture of expansion material and ground natural graphite is decoupled from the dissipation of heat to the outside that takes place directly or indirectly via the housing. Due to the heating element, the working point of the thermostatic working element can be set, and its control behavior can be improved while retaining the advantages that a working element has that includes a diaphragm and a working piston situated thereon. A thermostatic working element of this type can be used, advantageously, in a variety of applications, including in sanitary appliances to regulate the outlet temperature in a water circuit.

According to another advantageous design of the working element, the interior of the housing, which contains a mixture of expansion material and ground natural graphite, is tightly closed using a sealing stopper, and a working piston that dips into the mixture of expansion material and ground natural graphite extends through the sealing stopper, and can be expelled out of the mixture. The working piston is in direct contact, via its part situated in the housing interior, with the mixture of expansion material and additive. The advantages of the additive of ground natural graphite have a particularly favorable effect here since there is less friction, due to the reduction of the coefficient of friction, thereby resulting in the advantage of a short actuating time and high control accuracy. A thermostatic working element of this type can also be provided e.g. with an electric heating element. It can be contained e.g. in the interior of the working piston.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 a schematic sectional view of a thermostatic working element according to a first embodiment,

FIG. 2 a schematic sectional view of a thermostatic working element according to a second embodiment,

FIG. 3 a schematic sectional view of a thermostatic working element according to a third embodiment.

### DESCRIPTION OF THE PREFERRED EMBODIMENTS

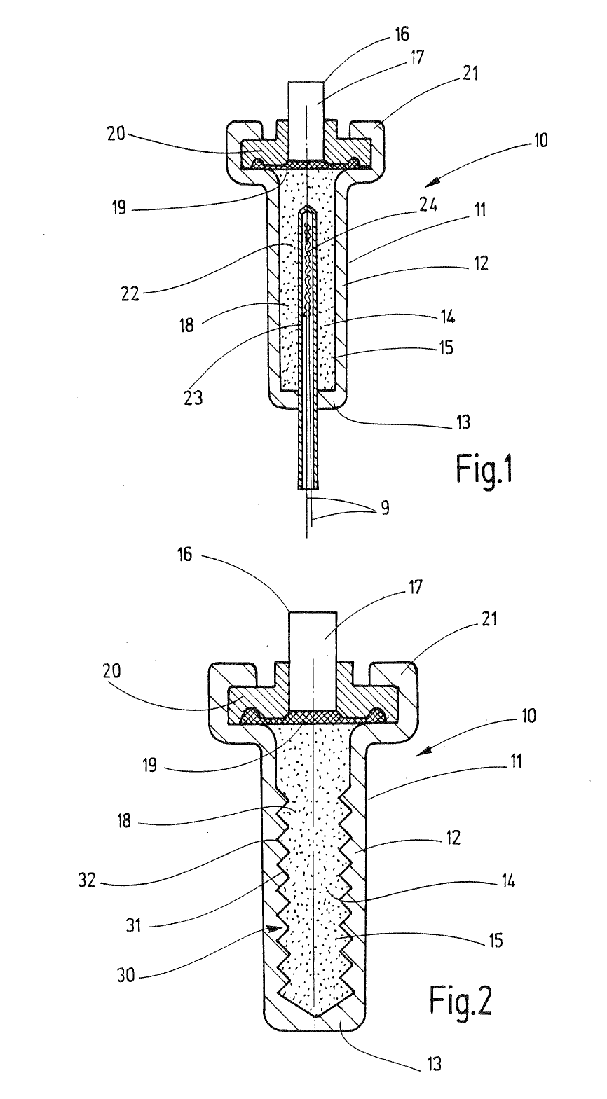

FIGS. 1 and 2 show a thermostatic working element 10 comprising an approximately pot-shaped, elongated housing 11 that includes an approximately cylindrical, tubular housing body 12 and a base 13 formed as a single piece therewith. An expansion material 15 is contained in housing interior 14, the volume of which is dependent on temperature, and which is used as means for expelling a working piston 16 which is composed of a cylindrical, in particular, pin 17 in the first and the second embodiment according to FIGS. 1 and 2. An additive 18, which is composed of ground natural graphite, is blended with expansion material 15. This is a highly pure and specially ground natural graphite having a special particle shape that results from the grinding procedure. This additive of ground natural graphite has the property that it is easily incorporated, contains very homogeneous particles, and does not tend to form sediment. Additive 18 results in a substantial increase in thermal conductivity and a reduction in the coefficient of friction of the mixture of expansion material 15 and additive 18.

Housing interior 14, which contains aforementioned mixture 15, 18, is tightly closed on the end opposite base 13 using a diaphragm 19. Diaphragm 19 has approximately resilient properties and is deformable. Diaphragm 19 is clamped in place using a guide part 20 that is held on the upper end of housing body 12 by a flange 21. Guide part 20 guides working piston 16 in the form of pin 17 which rests via its lower end on diaphragm 19 and, when the volume of expansion material 15 and additive 18 increases due to temperature, is expelled upward when diaphragm 19 shown in FIG. 1 deforms accordingly. Return means assigned to working element 10 are not shown, e.g. resilient return means that are used to return working piston 16 when working element 10, in particular housing 11 with contents, cools and the volume of expansion material 15 and additive 18 decreases.

Thermostatic working element 10 can be heatable e.g. using an electric heating element that is mounted e.g. on the outside in the region of base 13, or that encloses housing body 12 as a cuff. In the embodiment shown, an inner electric heating element 22 is provided that is contained in housing interior 14 and is in at least indirect physical contact with the mixture of expansion material 15 and additive 18. Electric heating element 22 is formed of an electrically heated pin element 23 that extends from base 13 of housing 11 deep into the housing interior 14. Pin element 23 extends through base 13, wherein pin element 23 is sealed off and fastened in this region e.g. via a press fit, soldering, a threaded connection, or the like. Pin element 23 is composed of a tube that contains, in its interior, an electric heating coil 24, which is shown schematically and is supplied by electrical lines 9 that extend into pin element 23 from the outside and are merely indicated. Due to this electric heating element 22, the control behavior of working element 10 is improved while the other advantages of working element 10 are retained. A short actuating time and high control accuracy are attained.

Additive 18 is designed such that its mean particle size D50 is in the range of approximately 2 um to 8 um. Additive 18 in the form of ground natural graphite can have a weight component of approximately 20% to 35%. Given a weight component of 20%, the thermal conductivity of the mixture of pure expansion material 15 and ground natural graphite 18 is approximately 1.1 W/mK, and is approximately 1.35 W/mK given a weight component of 30%.

Expansion material 15 is preferably composed of pure wax. It can have a thermal conductivity of approximately 0.3 W/mK.

The mixture of expansion material 15 and additive 18 in the form of ground natural graphite can be present in solid form e.g. as granulate, pellets, or the like. Additive 18 can also be added to expansion material 15 in liquid form, however.

In the manufacture of thermostatic working element 10 according to FIG. 1, additive 18 of ground natural graphite is blended with expansion material 15. The mixture with expansion material 14 can be in solid form and can take place before application. The mixture of expansion material 15 and additive 18 can be inserted into housing 11 in solid form e.g. as granulate, pellets, or the like. The mixing can also take place in a manner such that additive 18 is added to expansion material 15 in a liquid phase. The mixture of expansion material 15 and additive 18 can also be inserted into housing 11 in a liquid phase.

Thermostatic working element 10 described above has the advantage that the mixture of expansion material 15 and additive 18 in the form of ground natural graphite does not separate even over a long period of use, which would otherwise increase the reaction time. The advantage of working element 10 is the increased thermal conductivity between housing 11 and expansion material 15 with additive 18, which is contained in housing 11. This results in a reduction of the reaction time of working element 10. These advantages easily are attained. Working element 10 is simple and, above all, cost effective and ensures that its increased response time is maintained even during long periods of use and a long service life.

In a not-shown embodiment of working element 10 according to FIG. 1, means that increase the thermal conductivity between housing 11 and expansion material 15, possibly with incorporated additive 18, can be contained in housing interior 14, the means being composed e.g. of metallic conducting elements and/or conducting particles. These means can be formed as intermediate layers e.g. star-shaped metallic conducting elements placed in housing interior 12. A person skilled in the art is familiar with many different types of means of this type that increase thermal conductivity, which do not need to be presented or described here in detail.

The embodiment of a thermostatic working element 10 shown in FIG. 2 corresponds to that shown in FIG. 1, although with the addition of means 30 that increase thermal conductivity. In the second embodiment according to FIG. 2, means 30 are composed of inner projections 31 formed on the inside of housing body 12, which alternate with recesses 32 and increase the contact surface on the inside of housing body 12. Projections 31 can have diverse designs and can be formed e.g. of ribs or the like. Projections 31 are preferably created e.g. by thread turns of an internal thread or the like. It is easy to form an internal thread of this type, and minimal outlay is required. If housing body 12 is turned, the thread is cut. If housing body 12 is drawn, the inner thread can be shaped. In an embodiment of that type, it proves particularly advantageous to be able to inject the mixture of expansion material 15 and additive 18 into housing 11 in liquid form as well, wherein the mixture can also nicely fill the regions formed by recesses 32 or any other regions that are “shaded” by undercuts.

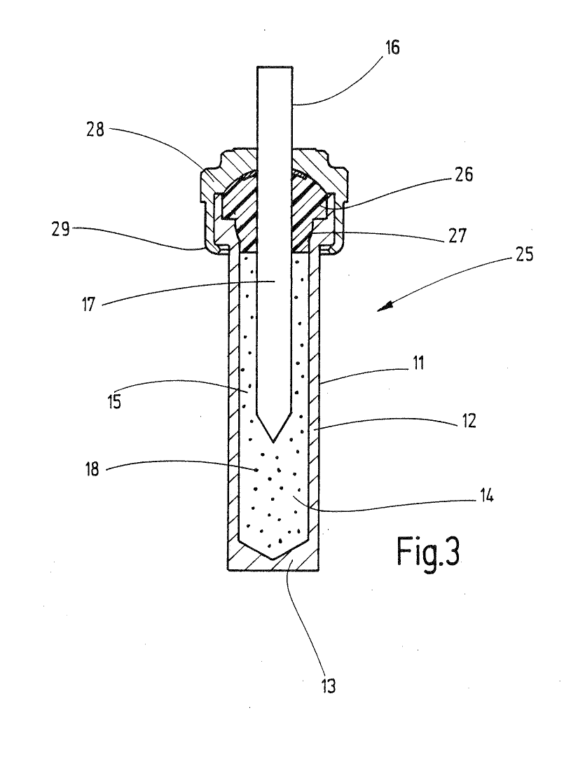

In the third embodiment, shown in FIG. 3, the same reference numerals are used for the components that correspond to the first embodiment according to FIG. 1, and so reference is made to the description of the first embodiment, to avoid repetition.

FIG. 3 shows a thermostatic working element 25, in the case of which a diaphragm 19 on the upper end of housing body 12 is replaced by a sealing stopper 26 that extends via a projection 27 into housing interior 14 and is covered by a cap 28 which is retained on housing 11 using a downward extending flange 29. Working piston 16 is formed of a longitudinal cylindrical pin 17 that extends through cap 28 and sealing stopper 26, and extends relatively far into the mixture of expansion material 15 and additive 18, and that can be expelled out of mixture 15, 18 when the temperature increases and the volume expands. Pin 17 has direct contact with the mixture of expansion material 15 and additive 18. In this design of working element 25, the reduction of the coefficient of friction and the increase in gliding quality, which is attained via additive 18 of ground natural graphite, has a particularly favorable effect since, when working piston 16 moves axially, relative motion occurs between working piston 16 and the mixture of expansion material 15 and additive 18.

Working element 25 can likewise be provided with an electric heating element, which is not shown further, wherein this electric heating element can also be disposed e.g. in the interior of working piston 16. It is also possible to use a pin element 23 according to FIG. 1 as the working piston, in which case electrical lines 9 are then run outwardly from the top.

It will be understood that each of the elements described above, or two or more together, may also find a useful application in other types of methods and constructions differing from the types described above.

While the invention has been illustrated and described as embodied in a thermostatic working element and method for manufacturing a thermostatic working element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A thermostatic working element, comprising a housing containing an expansion material, a volume of which is dependent on temperature, and which is used as means for expelling a working piston; and an additive of ground natural graphite blended with the expansion material.

2. The thermostatic working element as defined in claim 1, wherein the ground natural graphite has a mean particle size lying in a range between approximately 2 um and 8 um.

3. The thermostatic working element as defined in claim 1, wherein the ground natural graphite has a weight component of approximately between 20% and 35%.

4. The thermostatic working element as defined in claim 1, wherein a mixture of the expansion material and ground natural graphite has a thermal conductivity substantially 1.1 W/mK given a weight component of 20%.

5. The thermostatic working element as defined in claim 1, wherein a mixture of the expansion material and ground natural graphite has a thermal conductivity substantially 1.35 W/mK given a weight component of 30%.

6. The thermostatic working element as defined in claim 1, wherein a mixture of the expansion material and ground natural graphite is present in a solid form.

7. The thermostatic working element as defined in claim 6, wherein the mixture is present in solid form selected from the group consisting of granulate and pellets.

8. The thermostatic working element as defined in claim 1, wherein the additive is added to the expansion material in liquid form.

9. The thermostatic working element as defined in claim 1, wherein the expansion material is composed of pure wax.

10. A method for manufacturing a thermostatic working element, comprising the steps of providing a housing in which an expansion material and an additive are placed; using as the additive ground natural graphite; and blending the ground natural graphite with the expansion material.

11. The method as defined in claim 10, further comprising carrying out a mixing of the ground natural graphite with the expansion material in solid form.

12. The method as defined in claim 10, further comprising inserting a mixture of the expansion material with the ground natural graphite into the housing in a solid form.

13. The method as defined in claim 12, wherein said inserting the mixture includes inserting the mixture in the solid form selected from the group consisting of granulate and pellets.

14. The method as defined in claim 10, and further comprising carrying out mixing of the expansion material with the ground natural graphite in a manner such that the additive is added to the expansion material in a solid phase.

15. The method as defined in claim 10, further comprising inserting a mixture of the expansion material and the ground natural graphite into the housing in liquid form.

16. The method as defined in claim 14, further comprising using the expansion material composed of pure wax.

17. A thermostatic working element, comprising a housing containing an expansion material, a volume of which is dependent on temperature, and which is used as means for expelling a working piston; and means for increasing a thermal conductivity between said housing and said expansion material and contained in an interior of the housing.

18. The thermostatic working element as defined in claim 17, wherein said means are composed of elements selected from the group consisting of metallic conducting elements, conducting particles, and both.

19. The thermostatic working element as defined in claim 17, wherein said means are formed of intermediate layers.

20. The thermostatic working element as defined in claim 17, wherein said means are formed as structures selected from the group consisting of inner projections, inner recesses and both on an inside of said housing, and selected from the group consisting of ribs and thread turns of an interior thread.

21. The thermostatic working element as defined in claim 17, further comprising a diaphragm tightly closing the interior of said housing which contains the mixture of the expansion material and the ground natural graphite, said diaphragm being arranged so that the working piston rests on top of said diaphragm and the working piston is expellable via said diaphragm.

22. The thermostatic working element as defined in claim 17, further comprising an electric heating element fastened to said housing and located in the interior of said housing, said electric heating element being in at least indirect physical contact with a mixture of expansion material and the ground natural graphite.

23. The thermostatic working element as defined in claim 22, wherein said electric heating element is formed of an electrically heated pin element extending from a base of said housing deep into the interior of said housing.

24. The thermostatic working element as defined in claim 23, wherein said pin element in the interior of said housing contains at least one electric heating coil supplied by lines that extend into said pin element from outside.

25. The thermostatic working element as defined in claim 17, wherein the interior of said housing which contains the mixture of the expansion material and the ground natural graphite is tightly closed, further comprising a sealing stopper for tightly closing the interior of said housing; and a working piston dipping into the mixture of the expansion material and ground natural graphite so as to extend through said sealing stopper and is expellable out of the mixture.
